(19) United States
(12) Patent Application Publication
(10) Pub. No.: US 2016/0064173 A1
(43) Pub. Date: Mar. 3, 2016

(54) FUSE FOR HIGH-VOLTAGE APPLICATIONS

(71) Applicant: Cooper Technologies Company, Houston, TX (US)

(72) Inventors: James Robert Bukacek, Milwaukee, WI (US); James Allen Wenzel, Sullivan, WI (US); Alan Paul Yerges, Muskego, WI (US); Frank J. Muench, Waukesha, WI (US); Nicole Ewald, Rubicon, WI (US); Lisa Carol Sletson, Waterford, WI (US)

(21) Appl. No.: 14/469,413

(22) Filed: Aug. 26, 2014

(51) Int. Cl. H01H 85/042; H01H 85/165; H01H 85/143; H01H 85/08; H01H 85/06

(52) U.S. Cl. CPC H01H 85/042; H01H 85/08; H01H 85/06; H01H 85/143; H01H 85/165

(57) ABSTRACT

A current-limiting fuse for use at voltages between 23 kilovolts (kV) and 38 kV includes a body including a sidewall that at least partially defines an interior space; a fuse element in the interior space of the body, the fuse element wrapped around a non-conductive core and connected to first and second electrically conductive plates; and a non-bound particulate material in the interior space of the body, the non-bound particulate material including a plurality of pieces of the material with voids between at least some of the pieces. A fuse holder for use at voltages between 23 kV and 38 kV includes a housing for insertion in a sidewall of a transformer. The housing includes an exterior surface that defines an interior region. A fuse assembly is received in the interior region of the housing, the fuse assembly being configured to be replaced without opening the tank of the transformer.

### TECHNICAL FIELD

This disclosure relates to a fuse and a fuse system for high-voltage applications, such as a transformer that operates at a system voltage of, for example, between 23 kV and 38 kV, including 38 kV and voltages between 26.4 kV and 34.5 kV.

### BACKGROUND

A transformer is an electrical device that transfers energy between two circuits through electromagnetic induction. A fuse is an electrical device that includes a fuse element through which current flows between two conductive terminals to which the fuse element is connected. When exposed to an excessively high current, the fuse element melts, interrupting the flow of current between the two conductive terminals. Fuses, such as current-limiting fuses and expulsion fuses, may be used with the transformer to protect the transformer and/or equipment connected to the transformer from excessive currents.

### SUMMARY

In one general aspect, a current-limiting fuse for use at voltages between 23 kilovolts (kV) and 38 kV includes a body including a sidewall that at least partially defines an interior space; a first electrically conductive plate at a first end of the body and a second electrically conductive plate at a second end of the body; a non-conductive core in the interior space of the body; a fuse element in the interior space of the body, the fuse element wrapped around the non-conductive core and connected to the first electrically conductive plate and the second electrically conductive plate; and a non-bound particulate material in the interior space of the body, the non-bound particulate material including a plurality of pieces of the material with voids between at least some of the pieces.

Implementations may include one or more of the following features. The non-bound particulate material may fill the interior space of the body.

The non-bound particulate material may be associated with a packing factor that indicates a percentage of the interior space that is occupied by the pieces of the non-bound particulate material, and the packing factor may be between 62% and 75%. The non-bound particulate material may be associated with a packing factor that indicates a percentage of the interior space that is occupied by the pieces of the non-bound particulate material, and the packing factor may be between 65% and 70%. The non-bound particulate material may be associated with a packing factor that indicates a percentage of the interior space that is occupied by the pieces of the non-bound particulate material, and the packing factor may be between 69% and 70%.

The fuse element may include a grid pattern of openings, the centers of which are spaced relative to each other at a regular interval. The regular interval may be between 0.89 centimeters (cm) and 1.27 cm. The openings may include circular holes in a middle portion of the fuse element and partial circles at a perimeter of the fuse element.

In another general aspect, a fuse holder for use at voltages between 23 kV and 38 kV includes a housing for insertion in a sidewall of a tank of a transformer that is part of an electrical power system, the tank configured to receive a fluid in a space that is at least partially defined by the sidewall. The housing includes an exterior surface that defines an interior region, and a first electrical contact and a second electrical contact at the exterior surface of the housing, the first and second electrical contacts being separated from each other along a longitudinal axis of the housing. A fuse assembly is received in the interior region of the housing, the fuse assembly being configured to be replaced without opening the tank of the transformer and the fuse holder including a fuse cartridge, a first terminal contact at a first end of the fuse cartridge, a second terminal contact at a second end of the fuse cartridge, and a fusible element in the fuse cartridge, the fusible element being connected to the first and second terminal contacts.

Implementations may include one or more of the following features, the fusible element may be an alloy of silver-tin (Ag—Sn) or an alloy of cadmium-zinc-silver (Cd—Zn—Ag). The housing of the fuse assembly may define a plurality of vents that pass through the housing, the vents being configured to pass the fluid, such that, in use, the fuse assembly is submerged in the fluid. The first and second electrical contacts may be separated by a distance between 7.6 cm and 10.1 cm.

In another general aspect, a fuse assembly for a transformer includes a fuse cartridge including a first terminal contact at a first end and a second terminal contact at a second end, and a fusible element inside the fuse cartridge. The fusible element is connected to the first terminal contact and the second terminal contact, and the fusible element includes an alloy of silver-tin (Ag—Sn) or an alloy of cadmium-zinc-silver (Cd—Zn—Ag).

Implementations may include one or more of the following features. The fusible element may be the alloy of Ag—Sn, and the alloy may include 3.4-3.8% by mass of Ag and 96.2-96.6% by mass Sn. The fusible element may be the alloy of Cd—Zn—Ag, the alloy may include 77.9-78.9% by mass of Cd, 15.6-17.6% by mass of Zn, and 4.5-5.5% by mass of Ag.

The fusible element may be configured to be used with voltages between 23 kV and 38 kV. The fusible element may be configured to be used while submersed in fluid inside the transformer.

In another general aspect, a fuse system for use at voltages between 23 kV and 38 kilovolts (kV) includes a fuse holder including a housing for insertion in a sidewall of a tank of a transformer that is part of a power system, the housing defining an interior region, a fuse assembly received in the interior region of the housing, the fuse assembly configured for removal from the housing without opening the tank of the transformer. The fuse system also includes a current-limiting fuse configured to be connected in series with the fuse assembly, the current-limiting fuse including a body including a sidewall that at least partially defines an interior space, a first electrically conductive plate at a first end of the body and a second electrically conductive plate at a second end of the body, a non-conductive core in the interior space of the body, a fuse element in the interior space of the body, the fuse element wrapped around the non-conductive core and connected to the first electrically conductive plate and the second electrically conductive plate, and a non-bound particulate material in the interior space of the body, the non-bound particulate material including a plurality of pieces of the material with voids between at least some of the pieces of material.

Implementations may include one or more of the following features. The non-bound particulate material may fill the interior space of the body of the current-limiting fuse. The fuse assembly may include a fuse cartridge including an interior region, and a fusible element in the interior region of the fuse cartridge, the fusible element including an alloy of silver-tin (Ag—Sn) or an alloy of cadmium-zinc-silver (Cd—Zn—Ag).

The fuse assembly may be associated with a first current at which the fusible element melts to cause operation of the fuse assembly, the current-limiting fuse may be associated with a second current at which the fuse element melts to cause operation of the current-limiting fuse, the second current being greater than the first current, and the fusible element of the fuse assembly and the fuse element of the current-limiting fuse may be coordinated such that the current-limiting fuse only operates at a current that is higher than the second current.

The non-bound particulate material may be associated with a packing factor that indicates a percentage of the interior space that is occupied by the pieces of the non-bound particulate material, and the packing factor may be between 62% and 75%. The non-bound particulate material in the interior space of the body of the current-limiting fuse may be associated with a packing factor that indicates a percentage of the interior space that is occupied by the pieces of the non-bound particulate material, and the packing factor may be between 65% and 70%. The non-bound particulate material may be associated with a packing factor that indicates a percentage of the interior space that is occupied by the pieces of the non-bound particulate material, and the packing factor may be between 69% and 70%.

Implementations of any of the techniques described above may include a fuse, a current-limiting fuse, an expulsion fuse, a field-replaceable fuse, a fuse system that includes a plurality of fuses, a fuse system that includes a plurality of fuses that are coordinated with each other in high-voltage applications, a method of operating a fuse in a high-voltage application, and a method of assembling a fuse or a fuse system. The details of one or more implementations are set forth in the accompanying drawings and the description below. Other features will be apparent from the description and drawings, and from the claims.

### DRAWING DESCRIPTION

FIG. 1 is a block diagram of an exemplary power system that includes a fuse system.

FIG. 2A is a perspective view of an exemplary current-limiting fuse.

FIG. 2B is a side cross-sectional view of the current-limiting fuse of FIG. 2A.

FIG. 3A is a schematic of an exemplary fuse element for a current-limiting fuse.

FIG. 3B is a schematic of an expanded portion 3B of the fuse element of FIG. 3A.

FIG. 4 is a cross-sectional view of an exemplary non-conducting core that holds a fuse element of a current-limiting fuse.

FIG. 5A is a perspective view of an exemplary fuse holder.

FIG. 5B is a cross-sectional cut-away view of the fuse holder of FIG. 5A.

FIG. 6A is a side view of an exemplary fuse assembly.

FIG. 6B is a cross-sectional view of the fuse assembly of FIG. 6A taken along line 6B-6B.

FIG. 7 is an exemplary coordination plot for a system that includes a current-limiting fuse and a fuse holder.

### DETAILED DESCRIPTION

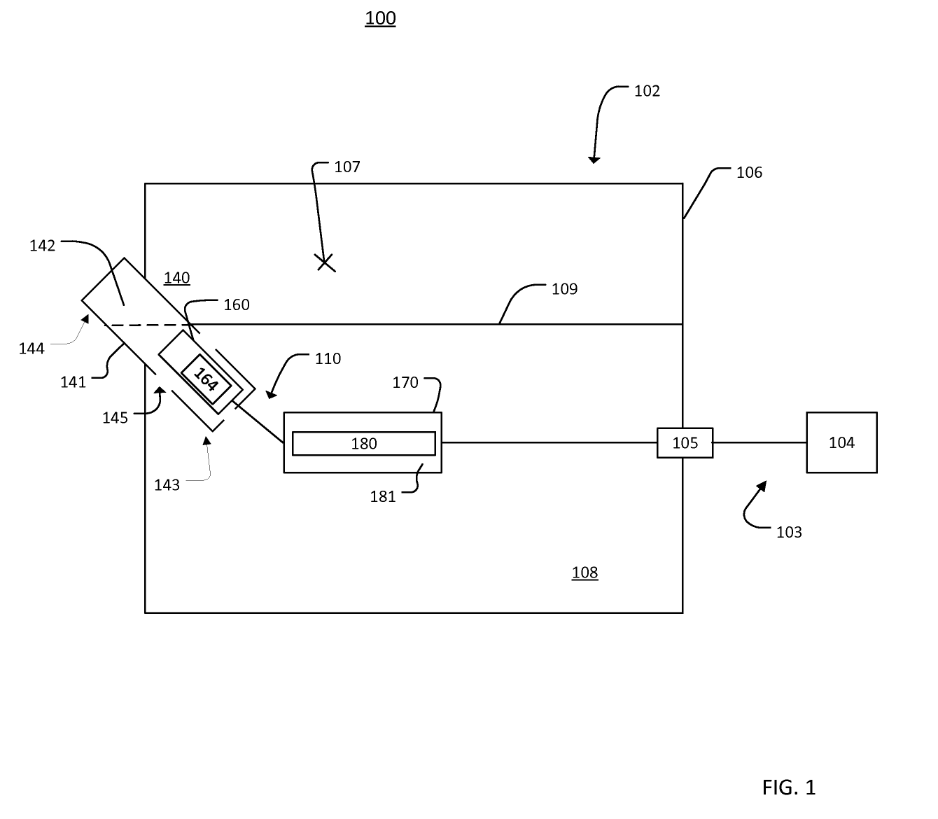

Referring to FIG. 1, a block diagram of an exemplary power system 100 is shown. The power system 100 includes a fuse system 110 for use with a transformer 102 in high-voltage applications (for example, applications between 23 kV and 38 kV, including applications at 38 kV and those between 26.4 kV and 34.5 kV). The transformer 102 may be, for example, a pad-mounted distribution transformer or a subsurface distribution transformer that is connected to electrical equipment 104. The fuse system 110 includes a current-limiting fuse 170 and a fuse holder 140, connected in series (as shown in FIG. 1). The current-limiting fuse 170 and the fuse holder 140 may be used as a coordinated fuse system in high-voltage applications, or used individually in high-voltage applications.

Under ordinary operating conditions of the power system 100, current flows between the transformer 102 and the equipment 104 on a path 103, allowing the transformer 102 to supply voltage and/or current to the equipment 104. Excessive currents caused by, for example, short circuits, equipment failure, and/or overloading in the power system 100 can damage the transformer 102 and/or the equipment 104. In the presence of extended and sustained excessive currents, the fuse system 110 protects the transformer 102 and the connected equipment 104 by interrupting current flow.

The transformer 102 includes a sidewall 106, which at least partially defines an interior space 107. The space 107 is accessible from outside the transformer 102 only by removing or opening a portion of the sidewall 106. The space 107 receives a fluid 108 that fills the space 107 to a fluid level 109. The fluid 108 may be any dielectric fluid that is stable at high temperatures and is sufficiently electrically insulative to suppress arcs. For example, the fluid 108 may be mineral oil, natural esters, synthetic esters, silicone fluid, vegetable oil, Envirotemp FR3, available from Cargill of Wayzata, Minn., or blends thereof. The fluid 108 aids the fuse holder 140 in interrupting current and suppresses arcs, which may occur during operation of the fuse system 110.

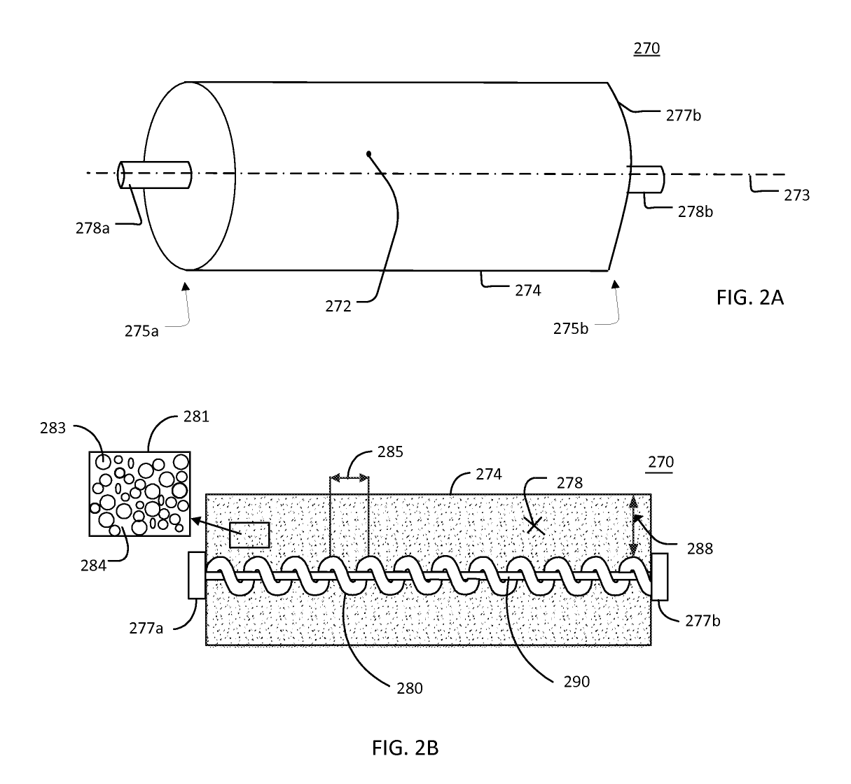

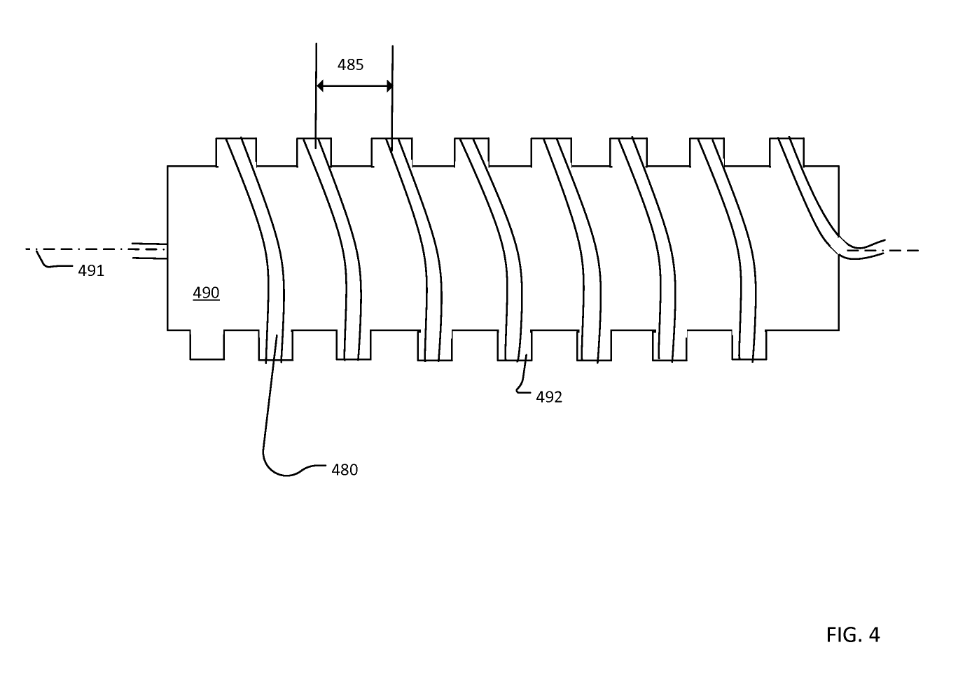

The fuse system 110 includes the current-limiting fuse 170, which is entirely located in space 107 and is submerged in the fluid 108, and the fuse holder 140, which is mounted through the sidewall 106. The current-limiting fuse 170 includes a fuse element 180, which is wrapped around a non-conductive core (such as the non-conductive core 290 of FIG. 2B or the non-conductive core 490 of FIG. 4). When exposed to a sufficiently high current, for example a current that exceeds the minimum interruption rating of the current-limiting fuse 170, the fuse element 180 melts and produces an arc.

The current-limiting fuse 170 also includes a filler material 181, which suppresses and extinguishes the arc. As discussed in greater detail with respect to FIGS. 2A and 2B, the filler material 181 is a non-bound particulate material that does not include any binder or any supporting materials that aid in removing heat from the fuse element 180. The characteristics of the filler material 181, as well as the structure and arrangement of the fuse element 180 and the non-conducting core, discussed with respect to FIGS. 2A, 2B, 3, and 4, allow the current-limiting fuse 170 to be used at high voltages with the non-bound, particulate filler material 181.

The fuse holder 140 also is configured for high-voltage applications. The fuse holder 140 has a housing 141 that defines an interior space 142. The housing 141 passes through the sidewall 106 of the transformer, with a lower portion 143 of the housing 141 extending into the space 107 and being below the fluid level 109. An upper portion 144 of the housing 141 is outside of the space 107 and on an exterior of the sidewall 106. The housing 141 also includes vents 145, which are open to the interior 142 and provide an opening through which the fluid 108 can flow into or out of the interior 142.

When the housing 141 is positioned in the sidewall 106, the lower portion 143 is below the fluid level 109, and the interior 142 of the housing 141 is in fluid communication with the interior space 107 of the transformer 102 through the vents 145. As a result, the fluid 108 enters the interior space 142 of the housing 141. A fuse assembly 160, which includes a fusible element 164, is received in the interior space 142 of the housing 141 and is exposed to the fluid 108. The arrangement of the housing 141 shown in FIG. 1, with the upper portion 144 being external to the sidewall 106, allows the fuse assembly 160 to be removed from the housing 141 without removing or opening a portion of the sidewall 106. This allows in-field replacement of the fuse assembly 160.

Additionally, the fuse holder 140 may be coordinated with the current-limiting fuse 170 in high-voltage applications (for example, applications between 23 kV and 38 kV, including applications at 38 kV and those between 26.4 kV and 34.5 kV). The coordination enables the fuse holder 140 to operate on (interrupt) overloads and faults external to the equipment being protected (which may be of relatively low magnitude) while reserving the current-limiting fuse 170 to interrupt higher magnitude internal fault currents that the fuse holder 140 cannot safely interrupt. Due to coordination, the current-limiting fuse 170, which is more challenging to replace because of its internal location in the transformer 102, does not operate on overloads and external fault currents that the fuse holder 140 can interrupt. As a result, the current-limiting fuse 170 may stay in service for a longer amount of time and have to be replaced less frequently. Thus, the coordination between the current-limiting fuse 170 and the fuse holder 140 may result in less system downtime and simpler repairs.

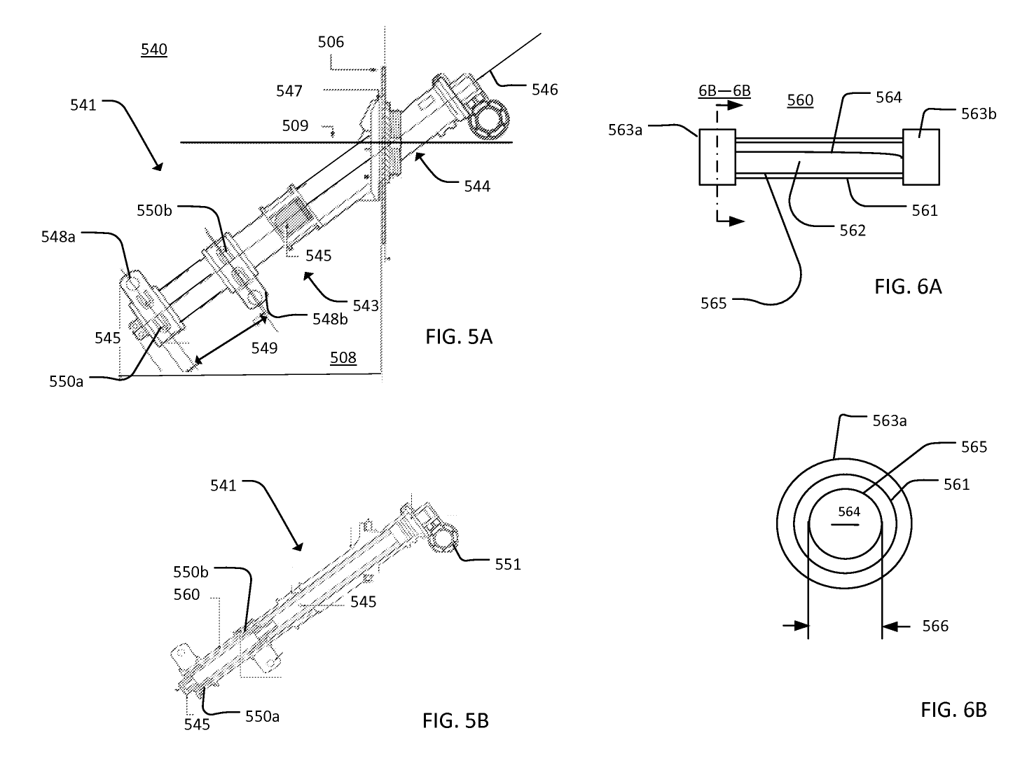

Further, and as discussed in more detail with respect to FIGS. 5A, 5B, 6A, and 6B, in some implementations, the fusible element 164 may be an electrically conductive alloy that includes silver, such as an alloy of, for example, cadmium-zinc-silver or tin-silver. The use of these alloys may help to achieve coordination between the current-limiting fuse 170 and the fuse holder 140 at high system voltages, for example, voltages between 23 kV and 38 kV, including 38 kV and voltages between 26.4 kV and 34.5 kV. Additionally, the ductility of these alloys may allow use in conditions where the fusible element 164 is exposed to rapid and/or repeated temperature changes due to variations in the amount of current that flows through the fusible element. Thus, the use of these alloys as the fusible element 164 may allow the fuse holder 140 to be used under strenuous cyclical loading situations in which current levels can change rapidly, such as those that may be encountered in wind energy or solar energy based applications.

Referring to FIGS. 2A and 2B, perspective and side cross-sectional views, respectively, of an exemplary current-limiting fuse 270, are shown. The current-limiting fuse 270 may be used as an individual component or the current-limiting fuse 270 may be paired with another fuse. For example, the current-limiting fuse 270 may be used as the current-limiting fuse 170 in the fuse system 110. The current-limiting fuse 270 is for use in high-voltage applications (for example, for example, voltages between 23 kV and 38 kV, including 38 kV and voltages between 26.4 kV and 34.5 kV). Additionally, the current-limiting fuse 270 may be used at these high voltages while submersed in a fluid, such as the fluid 108 (FIG. 1). In some implementations, the current-limiting fuse 270 may be used while not submersed in a fluid such as the fluid 108. For example, the current-limiting fuse 270 may be used in air.

The fuse 270 includes a body 272 that is formed from a sidewall 274. The sidewall 274 extends along a longitudinal axis 273 from a first end 275a to a second end 275b. At the respective ends 275a and 275b, the fuse 270 includes conductive end plates 277a, 277b and terminals 278a, 278b, which allow the fuse 270 to be electrically connected to another element.

The sidewall 274 defines an interior space 278 (FIG. 2B). Within the interior space 278 is a non-conductive core 290 that extends from the first end 275a to the second end 275b. A fuse element (or ribbon) 280 is wrapped around the non-conductive core 290. The fuse element 280 is made of an electrically conductive material, with one end connected to each of the end plates 277a, 277b.

Under ordinary conditions, current flows in the fuse element 280 between the conductive end plates 277a, 277b. When a current that falls between the minimum and maximum interruption ratings of the fuse 270 flows in the fuse element 280, the fuse element 280 melts, creating an open circuit to interrupt the current flow. When the fuse element 280 melts, an arc may form in the interior space 278 of the body 272. To suppress and extinguish the arc, the interior space 278 includes a particulate material 281 that is collection of a non-bound, or loose, particles or pieces of material 283, all or some of which are physically separated from other particles by voids 284. The voids 284 may be, for example, empty spaces or pockets of air.

The non-bound particulate material 281 contacts the interior components of the current-limiting fuse 270, including the non-conductive core 290 and the fuse element 280. The non-bound particulate material 281 may be a non-conductive material such as silica sand or quartz. The particles 283 may be grains of the silica sand or quartz. In some implementations, the particulate material 281 may be alumina or other oxide materials. Additionally, the particles 283 may have a range of grain size and/or shape distributions. Because of the shapes of the individual particles 283, a particle may touch a plurality of other particles while still having voids between the plurality of particles.

The particulate material 281 is loose and non-bound in that the particles 283 are not held together in a self-supporting structure that is formed by, for example, mixing a non-bound material with an inorganic binder. Additionally, the non-bound particulate material 281 includes only the particles 283 and the voids 284. The non-bound particulate material 281 lacks intentionally placed foreign materials, such as vaporizable resins, that may act to increase the heat removal ability of the non-bound particulate material 281.

Current-limiting fuses that are configured for use in high-voltage applications, for example those above 23 kV, typically employ a filler material that is bound with an inorganic binder to form a rigid, self-supporting structure inside the current-limiting fuse. The bound filler material absorbs heat from the fuse element and extinguishes the arc that forms when the fuse element melts. The use of the bound filler material may provide improved high current interruption (for example, a higher maximum interruption rating).

In contrast, the current-limiting fuse 270 uses the non-bound particulate material 281. The use of a non-bound filler material in a current-limiting fuse employed in high-voltage applications can present challenges. For example, the heating or melting of the fuse element may create pressure inside the current-limiting fuse, causing existing voids between the loose particles to expand. The presence of the voids may reduce the ability of the non-bound filler material to extinguish the arc. However, the current-limiting fuse 270, which is configured for use at high-voltages and includes a non-bound filler material (the non-bound particulate material 281), addresses these challenges through the characteristics of the non-bound filler material (such as the packing factor), and the configuration and arrangement of the fuse element 280 and the non-conducting core 290.

The portion of the interior space that is occupied by the particles 283 is one characteristic of the non-bound particulate material 281 that may help the current-limiting fuse 270 operate at high voltages. The non-bound particulate material 281 may fill the interior space 278 of the current-limiting fuse 270 such that there is no headroom, or clearance, between the non-bound particulate material 281 and the sidewall 274 and/or the end plates 277a, 277b. However, even without a clearance in the interior space 278, the voids 284 exist within the non-bound particulate material 281. The portion of the interior space 278 that is occupied by the particles 283 may be referred to as the packing factor. The packing factor depends on the size and shape of the particles 283 and the arrangement of the particles 283 relative to each other.

The packing factor may be any proportional quality or metric that characterizes the particles 283 relative to the interior space 278. The interior space 278 may be a volume, and the packing factor may be, for example, a percentage of the volume of the interior space 278 that is occupied by the particles 283. The packing factor may be based on, for example, a weight of the body 272 when it includes the non-bound particulate material 281 relative to a weight of the body 272 without the non-bound particulate material 281. The packing factor for the non-bound particulate material 281 may be, for example, less than 75%, between 60% and 75%, between 62% and 75%, or between 65% and 70%. In some implementations, the packing factor is between 69% and 70%.

As compared to a current-limiting fuse of the same size that employs a bound filler material, the current-limiting fuse 270 may weigh less. For example, the current-limiting fuse 270 with the non-bound particulate material 281 may be 4-16% lighter than a similar current-limiting fuse that has a bound arc-quenching filler material. Using the non-bound particulate material 281 also may result in the current-limiting fuse 270 being simpler and more efficient to manufacture as compared to a current-limiting fuse that employs a bound filler material. Further, the current-limiting fuse 270 can have a maximum interruption rating that is comparable to a fuse with a bound filler material.

Additionally, the use of the non-bound particulate material 281 with the other components of the current-limiting fuse 270 achieves a lower minimum interruption rating than a high-voltage current-limiting fuse that uses a bound filler material. For example, as compared to a current-limiting fuse that includes a bound filler material, the use of the non-bound particulate material 281 in the current-limiting fuse 270 may result in a 10-33% reduction in minimum interruption rating (in Amperes (A)) at a minimum melt between about 18,000 and 30,000 (in Amperes squared seconds (A²s)). The minimum melt is a measure of the amount of energy required to melt a fuse element based on application of a current for an amount of time.

In another example, the current-limiting fuse 270 has a continuous rated current, which is the amount of current that the fuse 270 is able to conduct without exceeding temperature limits, between, for example, 100 A and 140 A. When the current-limiting fuse 270 has a continuous rated current in this range, the use of the non-bound particulate material 281 may result in a beneficial 10-33% reduction in minimum interruption rating as compared to a current-limiting fuse that uses a bound filler material. For example, when the current-limiting fuse 270 was configured to have a continuous current rating of 100 A, the minimum interrupting current was 635 A. For a current-limiting fuse with a similar continuous current rating and a similar voltage rating but a bound filler, the minimum interrupting current was 700-720 A.

In a further example, when the current-limiting fuse 170 is configured to have continuous current ratings of 120 A and 140 A, the minimum interruption ratings were 700 A and 800 A, respectively. Additionally, these minimum interruption ratings are lower than the 900 A minimum interruption rating of a current-limiting fuse that uses a bound material filler and has a continuous current rating of 125 A. Thus, the current-limiting fuse 270 may provide a reduction in minimum interruption rating while maintaining a sufficient maximum current interruption rating.

In addition to the non-bound particulate material 281, the structure and positioning of the fuse element 280 also may allow the current-limiting fuse 270 to be used in high-voltage applications. Placing the fuse element 280 in close proximity to the sidewall 274 may result in the sidewall 274 scorching and releasing gas when the fuse element 280 heats or melts. The additional gas released from the sidewall 274 can increase the pressure in the interior space 278, and can cause the end plates 277a, 277b to separate from the body 272. Separation of the end plates 277a, 277b may prevent interruption. Thus, the fuse element 280 is positioned in the interior space 278 at a distance 288 from the sidewall 274 that minimizes the release of gas from the sidewall 274 while still allowing the overall size of the fuse 270 to remain the same. The distance 288 may be, for example, at least 0.2 inches (0.51 cm), 0.2 to 0.4 inches (0.51 to 1.02 cm), 0.3 to 0.4 inches (0.76 to 1.02 cm), or 0.35 to 0.4 inches (0.90 to 1.02 cm).

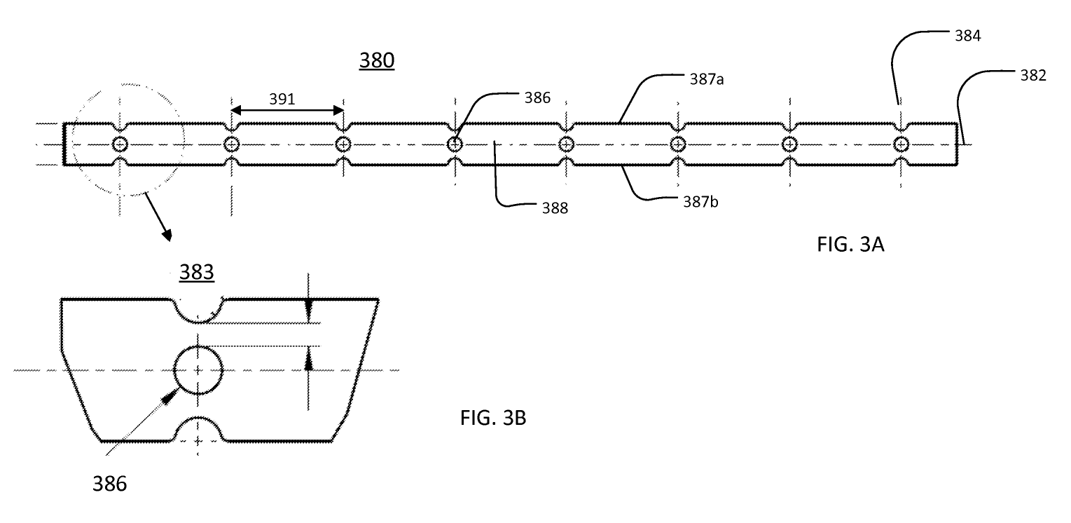

Referring also to FIGS. 3A and 3B, an exemplary fuse element 380 is shown. The fuse element 380 may be used as the fuse element 180, 280 in the current-limiting fuse 170, 270, respectively. FIG. 3A shows the fuse element 380 is shown in an unwound state, prior to placement around the non-conductive core 290. FIG. 3B shows a subsection 383 of the fuse element 380.

The fuse element 380 is a strip of electrically conductive material, such as copper or silver, that has a longitudinal axis 382, and a lateral axis 384, which is perpendicular to the longitudinal axis 382. The fuse element 380 has a collection of openings 386 having positions that form a grid pattern on the fuse element 380. In the example of FIG. 3A, the openings 386 are positioned along a center portion 388 and edges 387a, 387b of the fuse element 380. The subsection 383 shows a single column of openings 386. In the example of FIG. 3B, the centers of the openings 386 in the column are aligned along a direction that is parallel to the lateral axis 384.

In the example of FIGS. 3A and 3B, the openings 386 are circular. The openings 386 positioned along the center portion 388 have cross-sections that are complete circles, and the openings 386 at the edges 387a, 387b have cross-sections that are partial circles. Each of the openings 386 is separated along a direction that is parallel to the longitudinal axis 382 by a distance 391. The distance 391 may be, for example, 0.4 inches (1.106 cm), between 0.35 inches and 0.5 inches (between 0.89 cm and 1.27 cm), between 0.38 inches and 0.45 inches (between 0.96 cm and 1.14 cm), or between 0.39 inches and 0.41 inches (between 0.99 cm and 1.04 cm). The distance 391 may be measured from the middle of one opening to the middle of the adjacent opening along a direction that is parallel to the longitudinal axis 382. In the example of FIG. 3A, each of the openings 386 that is at the edge 387a is aligned, in a direction that is parallel to the lateral axis 384, with an opening 386 in the center of the fuse element 380 and another opening 386 on the edge 387b. The openings 386 may be holes that pass through the fuse element 380.

In other examples, the openings 386 may have cross-sections of shapes other than a circle. Additionally, a single fuse element 380 may include openings that have a variety of cross-sectional shapes.

The arrangement of the openings 386 in the grid pattern helps the current-limiting fuse 270 perform in high-voltage applications with the non-bound particulate material 281. The fuse element 380 may include a greater number of openings 386 per inch (or other unit of length) than a fuse element typically used in a current-limiting fuse with a bound filler, with smaller values of the distance 391 providing more openings 386 per unit length. When a current that exceeds the minimum interruption rating flows in the fuse element 380, the fuse element 380 heats and begins to melt. The fuse element 380 melts first at the openings 386, because the openings 386 are relatively thinner than the other portions of the fuse element 380, and arcs form at the openings 386. By having a greater density of openings 386, there are more arc points and a higher resistance. Although a higher resistance may be undesirable, a greater density of arc points may be beneficial. With the configuration of openings 386 discussed above, the arcing is distributed spatially along the fuse element 380, improving the efficiency of the current interruption and allowing the non-bound particulate material 281 to extinguish the arc.

In the example, of FIGS. 3A and 3B, the openings 386 have cross-sectional shapes that are circular or partial-circles. The circular shape may provide manufacturing efficiencies. Additionally, the circular shape provides the minimum cross-sectional area for the openings 386. By minimizing the cross-sectional area, the resistance caused by the openings 386 is reduced while keeping the fuse element melt and current interruption characteristics the same. The spatial arrangement of the openings 386 on the fuse element 380 also provides the lower resistance despite the increased number of openings 386. For the same minimum cross-sectional area of the fuse element 380, the grid pattern of FIG. 3A, which has one opening in the center portion 300 and one partial openings at each of the edges 387a, 387b for each column of openings along the lateral axis 384 (such as shown in FIG. 3B), provides a lower resistance than a grid that includes just one opening.

When the openings 386 have circular cross-sections, the diameter of the cross-section may be, for example, 0.062 inches (0.157 cm). The openings 386 that have cross-sections that are partial circles can have a cross-sectional width that is a fraction of the cross-sectional diameter of the openings that have circular cross-sections.

Referring again to FIG. 2B, in the assembled current-limiting fuse 270, the fuse element 280 is wrapped around the non-conductive core 290 to form a helix, spiral, or a coil shape that has smooth, curved turns. Two sequential segments of the coil are spaced from each other by a distance 285 along a direction that is parallel to the longitudinal axis of the non-conductive core 290.

During current interruption, the fuse element 280 melts and an arc is produced. As compared to a bound filler, the particulate material 281 used in the current-limiting fuse 270 may provide less confinement of the arc and less heat absorption. As a result, without modifications to the fuse element, the arc may persist for a longer time in a fuse that uses a non-bound filler material than in a fuse that has a bound filler. However, by increasing the spacing between the turns (the distance 285), the pressure generated by the arc can be reduced to help the current-limiting fuse 270 to be used in high-voltage applications with a the non-bound filler material 281. In some implementations, such as shown in FIG. 4, the non-conductive core 290 has a geometric features that hold the fuse element 280 in a coil or helix shape with the coil segments separated by the distance 285.

Referring to FIG. 4, a side cross-sectional view of an exemplary non-conductive core 490 is shown. A fuse element 480 is wrapped around the non-conductive core 490 in a spiral or coil shape. The non-conductive core 490 and the fuse element 480 may be used as the non-conductive core 290 and the fuse element 280, respectively, in the current-limiting fuse 270. The fuse element 380 may be wrapped around the non-conductive core 490. The non-conductive core 490 may be made from, for example, mica laminate or any other material that does not generate gas sufficient to contribute to pressure build up when the fuse element 480 melts or heats.

The non-conductive core 490 has a longitudinal axis 491 and geometric features 492. The non-conductive core 490 provides support for the wound fuse element 480, and the geometric features 492 hold the wound fuse element 480 with the coil segments spaced from each other by a distance 485 along a direction that is parallel to the longitudinal axis 491. The distance 485 determines the spacing between coil segments. Thus, to increase the distance between the coil segments, the distance 485 between the geometric features 492 may be increased.

As discussed above, increasing the spacing between the coil segments helps the current-limiting fuse 170 operate in high-voltage applications with a non-bound material filler. The distance 485 may be, for example, 0.64 inches to 0.8 inches (1.6 cm to 2 cm).

Thus, the current-limiting fuse 270 is a fuse for high-voltage applications that uses a non-bound particulate material 281 as the arc-quenching filler. The structure and arrangement of the components of the current-limiting fuse 270, such as the fuse element 280, the non-conductive core 290, and/or the non-bound particulate material 281, allows the current-limiting fuse 270 to be used in high-voltage applications. Additionally, the current-limiting fuse 270 may achieve a lower minimum interruption rating than a current-limiting fuse that uses a non-bound filler as the arc-quenching filler medium.

Referring again to FIG. 1, the fuse system 110 includes the current-limiting fuse 170 and the fuse holder 140. The current-limiting fuse 170 and the fuse holder 140 may be used together as the fuse system 110, or these components may be used individually and separate from each other. An example of a current-limiting fuse 270 that may be used as the current-limiting fuse 170 is discussed above with respect to FIGS. 2A, 2B, 3A, 3B, and 4. The discussion with respect to FIGS. 5A, 5B, 6A, and 6B, below, relates to an exemplary fuse holder 540 that may be used as the fuse holder 140.

Referring to FIG. 5A, a perspective view of an exemplary fuse holder 540 is shown. FIG. 5B shows a cut-away view of the fuse holder 540. FIG. 6A shows a block diagram of a side view of an exemplary fuse assembly 560, which may be received in the fuse holder 540, and FIG. 6B shows a cross-sectional view of the fuse assembly 560 taken along line 6B-6B of FIG. 6A.

The fuse holder 540 is a field-replaceable under-oil expulsion fuse for use in high-voltage (for example, voltages between 23 kV and 38 kV, including 38 kV and voltages between 26.4 kV and 34.5 kV) applications. The fuse holder 540 may have a continuous current rating of, for example, 10-65 A. The fuse holder 540 may be used with the current-limiting fuse 170 or 270 to form a fuse system that includes a field-replaceable expulsion fuse for use in high-voltage applications. The fuse holder 540 may be used with a current-limiting fuse other than the current-limiting fuses 170, 270, or with another type of fuse. Additionally, the fuse holder 540 may be used as a single component that does not directly connect to another fuse.

The fuse holder 540 includes a fuse housing 541 that defines a longitudinal axis 546. The fuse housing 541 has a flange 547, with a lower portion 543 of the housing 541 being on one side of the flange 547 and an upper portion 544 of the housing 541 being on the other side of the flange 547. In use, the fuse holder 540 is positioned in a sidewall 506 of a tank of a transformer (such as the transformer 102 of FIG. 1). The flange 547 is used to secure the housing 541 to the sidewall 506 and to seal the interior of the transformer while the housing 541 is positioned in the sidewall 506. While the housing 541 is positioned in the sidewall 506, the lower portion 543 extends into the tank of the transformer and the upper portion 544 extends outward from the sidewall 506. All or part of the lower portion 543 is submerged in a fluid 508 that is held up to a level 509 in the tank of the transformer. The housing 541 also includes vents or ports 545 that are open to the exterior of the housing 541. The vents 545 allow gasses that build up in the housing 541 to escape, and the vents also allow the fluid 508 in the transformer tank to enter the interior of the housing 541.

Mounted on the exterior surface of the housing 541 are electrical contacts 548a, 548b. The electrical contacts 548a, 548b may be made of any electrically conductive material such as, for example, copper or silver. The fuse holder 540 may be connected to circuitry within the transformer and/or another electrical element (such as the current-limiting fuse 170) through one or both of the electrical contacts 548a, 548b. The electrical contacts 548a, 548b include contact buttons 550a, 550b, respectively. The contact buttons 550a, 550b are made from any electrically conductive material.

The electrical contacts 548a, 548b are spaced (separated) from each other along a direction that is parallel to the longitudinal axis 546 by a distance 549. The electrical contacts 548a, 548b are separated from each other such that the electrical contacts 548a, 548b do not make direct physical contact. The distance 549 may be, for example, greater than 3 inches (7.62 cm), or between 3 inches and 4 inches (between 7.62 cm and 10.16 cm). The distance 549 helps the fuse holder 540 operate properly in high-voltage applications and is longer than a similar distance on a fuse holder intended for a lower voltage application. As the distance 549 increases, the housing 541 is able to withstand greater voltage because of the increased dielectric strength longer length provides. Additionally, the longer length also reduces the chance of restrikes (re-initiation of current after interruption), because of the better dielectric strength.

Referring also to FIGS. 5B and 6A, a fuse assembly 560 is received in an interior of the housing 541. The fuse assembly 560 is received in the lower portion 543 of the housing 541. The fuse assembly 560 includes a fuse cartridge 561 that defines an interior region 562. The fuse assembly 560 also may include a fuse link 565 in the interior region 562. The fuse link 565 holds a fusible element 564, which is discussed below. The fuse link 565 may be concentric with the fuse cartridge 561.

The fuse cartridge 561 has a first terminal contact 563a at a first end of the fuse cartridge 561, and a second terminal contact 563b at a second end of the fuse cartridge 561. The terminal contacts 563a, 563b may be made of any electrically conductive material. When the fuse assembly 560 is in the interior of the housing, each of the terminal contacts 563a, 563b are electrically connected to one of the contact buttons 550a, 550b. In this manner, the fuse assembly 560 is electrically connected to the electrical contacts 548a, 548b that are on the exterior of the housing 541. Thus, when the fuse assembly 560 is in the interior of the housing 541, an element that is electrically connected to the fuse holder 540 through the electrical contacts 548a, 548b is also electrically connected to the fuse assembly 560.

The fuse assembly 560 may be removed from the fuse housing 541 by opening or flipping a latch handle 551 that is formed on the housing 541. Opening the latch handle 551 breaks the seal that the flange 547 forms between the housing 541 and the sidewall 506 of the transformer. The fuse assembly 560 may be removed from the lower portion of the interior of the housing 541 by pulling the latch handle 551 and the upper portion 544 of the housing 541 away from the sidewall 506 of the transformer. In this manner, the fuse holder 540 allows for in-field replacement of the fuse assembly 560 because the tank of the transformer does not have to be opened or otherwise removed to replace the fuse assembly 560.

A fusible element 564 is in the interior region 562 and extends between the terminal contacts 563a, 563b. The fusible element 564 is made of any electrically conductive material, and, under ordinary conditions, current flows between the terminal contacts 563a, 563b in the fusible element 564. When the fuse assembly 560 is exposed to a sustained excessive current, the fusible element 564 melts, interrupting current flow between the terminal contacts 563a, 563b, and protecting equipment and/or circuitry that the fuse holder 540 is connected to through the electrical contacts 548a, 548b.

Referring to FIG. 6B, a cross-sectional view of the fuse assembly 560 taken along the line 6B-6B of FIG. 6A. In the example of FIGS. 6A and 6B, the fuse cartridge 561 and the fuse link 565 are concentric tubes, with the fuse link 565 having a diameter 566 that is smaller than a diameter than the fuse cartridge 561. Reducing the value of the diameter 566 may improve low current interruption, but a diameter that is too small may lead to an unwanted increase in pressure in high-voltage applications. The diameter of the fuse link 565 may be, for example, between 0.180 and 0.240 inches (between 0.45 cm and 0.61 cm), or between 0.205 inches and 0.228 inches (between 0.521 cm and 0.579 cm) for high-voltage applications and current ratings of 10 A to 65 A.

The fusible element 564 may be any electrically conductive material. For example, the fusible element may be tin (Sn), silver (Ag), copper (Cu), a tin-copper alloy, a tin-lead (Pb)-cadmium (Cd) alloy or an alloy that includes tin, lead, silver, and/or other materials that conduct electricity. The fusible element 564 may be, for example, 4.5 inches (11.43 cm) long.

In some implementations, the fusible element 564 is an alloy that includes silver, such as, for example, an alloy of tin and silver (Ag—Sn) or an alloy of cadmium, zinc, and silver (Cd—Zn—Ag). In implementations in which the fusible element 564 is an Ag—Sn alloy, the alloy may include, by mass, 4% or less of silver, and 96% or greater of tin. In other implementations, the alloy includes 3.6%, by mass, of silver and 96.4% by mass of tin. In still other implementations, the alloy includes 3.4-3.8%, by mass, of silver and 96.2-96.6%, by mass, of tin. In implementations in which the fusible element 564 is a Cd—Zn—Ag alloy, the alloy may include 77.9-78.9%, by mass, of cadmium, 15.6-17.6%, by mass, of zinc, and 4.5-5.5%, by mass, of silver. In other implementations, the fusible element 564 is a Cd—Zn—Ag alloy that includes 78%, by mass, of cadmium, 17%, by mass, of zinc, and 5%, by mass, of silver. In other implementations, the fusible element 564 is a Cd—Zn—Ag alloy that includes 78.4%, by mass, of cadmium, 16.6%, by mass, of zinc, and 5%, by mass, of silver. Impurities and other materials may be 0.15% or less, by mass, of the alloy.

When used as the fusible element 564, the Cd—Zn—Ag alloy may provide improved performance when the fuse assembly experiences cyclic loading conditions in high-voltage (voltages between 23 kV and 38 kV, including 38 kV and voltages between 26.4 kV and 34.5 kV) at up to a 65 A continuous current rating, and the Sn—Ag alloy may provide improved performance in this voltage range at up to a 40 A continuous current rating. Additionally, the Cd—Zn—Ag and Sn—Ag alloys may be used in a system that includes the fuse holder 540 and a current-limiting fuse that operates at high-voltages (such as the current-limiting fuses 170 and 270 discussed above), and these alloys may enhance and/or allow the coordination between the fuse holder and the current-limiting fuse.

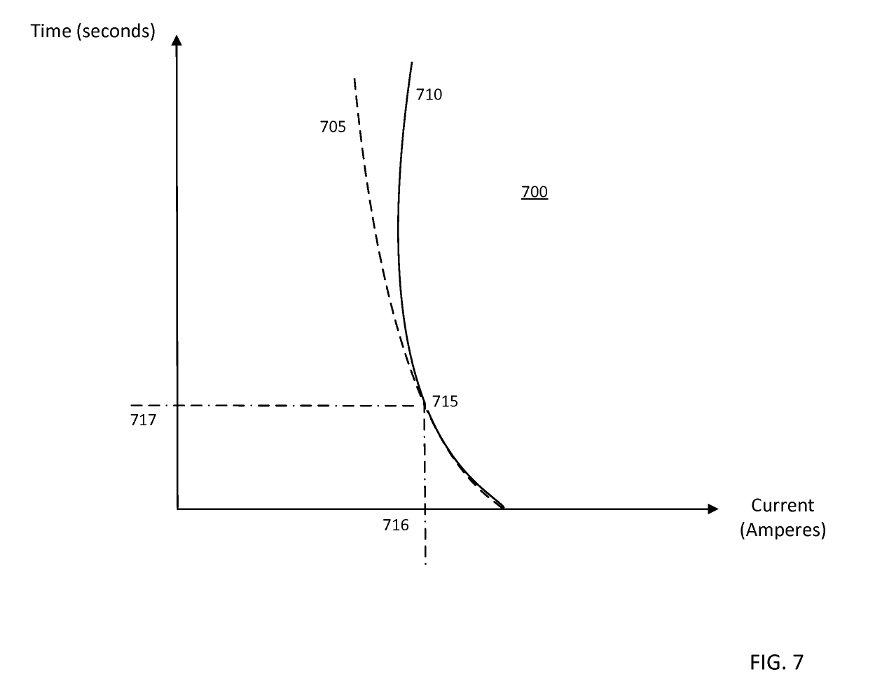

Referring to FIG. 7, an exemplary coordination plot 700 is shown. The coordination plot 700 is an example of a coordination plot for the fuse system 110 (FIG. 1). The coordination plot 700 illustrates how the fuse holder 140 and the current-limiting fuse 170 are coordinated to act together as the fuse system 110. In the example shown, the fuse holder 140 has a rated voltage of 38 kV, a continuous current rating of 65 A, and a fusible element made of a Cd—Zn—Ag alloy. In this example, the current-limiting fuse 170 has a rated voltage of 38 kV and a continuous current rating of 100 A.

The coordination plot 700 includes a curve 705 (shown with a dashed line) that represents the total clearing time-current characteristic of the fuse holder 140. The total clearing time-current characteristic represents the total time, in seconds, for the fuse holder 140 to interrupt a fault current as a function of the fault current in Amperes. The coordination plot 700 also includes a curve 710 that represents a minimum melting time-current characteristic of the current-limiting fuse 170. The minimum melting time-current characteristic represents the minimum time, in seconds, after which the fuse element of the current-limiting fuse may begin to melt as a function of the amount of current flowing in the fuse element in Amperes.

The curves 705 and 710 intersect at a crossover point 715, which is associated with a current 716 and a time 717. If the current 716 is equal to or greater than the minimum interruption rating of the current-limiting fuse 170 and less than the maximum current that the fuse holder 140 is able to interrupt, the current-limiting fuse 170 and the fuse holder 140 are coordinated. In this scenario, the current-limiting fuse 170 only operates at currents that are greater than its minimum interruption current, because lower value currents are interrupted by the fuse holder 140.

Due to coordination, the current-limiting fuse 170, which is more challenging to replace because to its internal location in the transformer 102, does not operate on fault currents that the fuse holder 140 can interrupt. Thus, the coordination between the current-limiting fuse 170 and the fuse holder 140 may result in less system downtime and simpler repairs. Additionally, the current-limiting fuse 170 interrupts currents that are too high for the fuse holder 140 to safely interrupt. Because the time-current characteristic curves depend on the current at which the fuse element melts, a particular material for fuse element, such as the silver-tin or cadmium-zinc-silver alloys discussed above, may be used to provide coordination between the current-limiting fuse 170 and the fuse holder 140 in high-voltage applications.

Other features are within the scope of the claims. For example, the fuse system 110, the fuses 170 and 270, the fuse holders 140 and 540, and the fuse assembly are discussed with respect to a transformer, but may be used with other high-voltage electrical components, such as a high-voltage electrical switchgear.

What is claimed is:

1. A current-limiting fuse for use at voltages between 23 kilovolts (kV) and 38 kV, the current-limiting fuse comprising:
a body comprising a sidewall that at least partially defines an interior space;
a first electrically conductive plate at a first end of the body and a second electrically conductive plate at a second end of the body;
a non-conductive core in the interior space of the body;
a fuse element in the interior space of the body, the fuse element wrapped around the non-conductive core and connected to the first electrically conductive plate and the second electrically conductive plate; and
a non-bound particulate material in the interior space of the body, the non-bound particulate material comprising a plurality of pieces of the material with voids between at least some of the pieces.

2. The current-limiting fuse of claim 1, wherein the non-bound particulate material fills the interior space of the body.

3. The current-limiting fuse of claim 1, wherein the non-bound particulate material is associated with a packing factor that indicates a percentage of the interior space that is occupied by the pieces of the non-bound particulate material, and the packing factor is between 62% and 75%.

4. The current-limiting fuse of claim 1, wherein the non-bound particulate material is associated with a packing factor that indicates a percentage of the interior space that is occupied by the pieces of the non-bound particulate material, and the packing factor is between 65% and 70%.

5. The current-limiting fuse of claim 1, wherein the non-bound particulate material is associated with a packing factor that indicates a percentage of the interior space that is occupied by the pieces of the non-bound particulate material, and the packing factor is between 69% and 70%.

6. The current-limiting fuse of claim 1, wherein the fuse element comprises a grid pattern of openings, the centers of which are spaced relative to each other at a regular interval.

7. The current-limiting fuse of claim 6, wherein the regular interval is between 0.89 centimeters (cm) and 1.27 cm.

8. The current-limiting fuse of claim 6, wherein the openings comprise circular holes in a middle portion of the fuse element and partial circles at a perimeter of the fuse element.

9. A fuse holder for use at voltages between 23 kV and 38 kV, the fuse holder comprising:
a housing for insertion in a sidewall of a tank of a transformer that is part of an electrical power system, the tank configured to receive a fluid in a space that is at least partially defined by the sidewall, the housing comprising:
an exterior surface that defines an interior region, and
a first electrical contact and a second electrical contact at the exterior surface of the housing, the first and second electrical contacts being separated from each other along a longitudinal axis of the housing; and
a fuse assembly received in the interior region of the housing, the fuse assembly being configured to be replaced without opening the tank of the transformer and the fuse holder comprising:
a fuse cartridge,
a first terminal contact at a first end of the fuse cartridge,
a second terminal contact at a second end of the fuse cartridge, and
a fusible element in the fuse cartridge, the fusible element being connected to the first and second terminal contacts.

10. The fuse holder of claim 9, wherein the fusible element comprises an alloy of silver-tin (Ag—Sn) or an alloy of cadmium-zinc-silver (Cd—Zn—Ag).

11. The fuse holder of claim 10, wherein the housing of the fuse assembly defines a plurality of vents that pass through the housing, the vents being configured to pass the fluid, such that, in use, the fuse assembly is submerged in the fluid.

12. The fuse holder of claim 9, wherein the first and second electrical contacts are separated by a distance between 7.6 cm and 10.1 cm.

13. A fuse assembly for a transformer, the fuse assembly comprising:
a fuse cartridge comprising a first terminal contact at a first end and a second terminal contact at a second end; and
a fusible element inside the fuse cartridge, wherein
the fusible element is connected to the first terminal contact and the second terminal contact, and
the fusible element comprises an alloy of silver-tin (Ag—Sn) or an alloy of cadmium-zinc-silver (Cd—Zn—Ag).

14. The fuse assembly of claim 13, wherein the fusible element comprises the alloy of Ag—Sn, the alloy comprising 3.4-3.8% by mass of Ag and 96.2-96.6% by mass Sn.

15. The fuse assembly of claim 13, wherein the fusible element comprises the alloy of Cd—Zn—Ag, the alloy comprising 77.9-78.9% by mass of Cd, 15.6-17.6% by mass of Zn, and 4.5-5.5% by mass of Ag.

16. The fuse assembly of claim 13, wherein the fusible element is configured to be used with voltages between 23 kV and 38 kV.

17. The fuse assembly of claim 13, wherein the fusible element is configured to be used while submersed in fluid inside the transformer.

18. A fuse system for use at voltages between 23 kV and 38 kilovolts (kV), the fuse system comprising:
a fuse holder comprising:
a housing for insertion in a sidewall of a tank of a transformer that is part of a power system, the housing defining an interior region,
a fuse assembly received in the interior region of the housing, the fuse assembly configured for removal from the housing without opening the tank of the transformer; and
a current-limiting fuse configured to be connected in series with the fuse assembly, the current-limiting fuse comprising:
a body comprising a sidewall that at least partially defines an interior space,
a first electrically conductive plate at a first end of the body and a second electrically conductive plate at a second end of the body,
a non-conductive core in the interior space of the body,
a fuse element in the interior space of the body, the fuse element wrapped around the non-conductive core and connected to the first electrically conductive plate and the second electrically conductive plate, and
a non-bound particulate material in the interior space of the body, the non-bound particulate material comprising a plurality of pieces of the material with voids between at least some of the pieces of material.

19. The fuse system of claim 18, wherein the fuse assembly comprises:
a fuse cartridge comprising an interior region, and
a fusible element in the interior region of the fuse cartridge, the fusible element comprising an alloy of silver-tin (Ag—Sn) or an alloy of cadmium-zinc-silver (Cd—Zn—Ag).

20. The fuse system of claim 19, wherein
the fuse assembly is associated with a first current at which the fusible element melts to cause operation of the fuse assembly,
the current-limiting fuse is associated with a second current at which the fuse element melts to cause operation of the current-limiting fuse, the second current being greater than the first current, and
the fusible element of the fuse assembly and the fuse element of the current-limiting fuse are coordinated such that the current-limiting fuse only operates at a current that is higher than the second current.

21. The fuse system of claim 20, wherein the non-bound particulate material in the interior space of the body of the current-limiting fuse is associated with a packing factor that indicates a percentage of the interior space that is occupied by the pieces of the non-bound particulate material, and the packing factor is between 65% and 70%.

22. The current-limiting fuse of claim 20, wherein the non-bound particulate material is associated with a packing factor that indicates a percentage of the interior space that is occupied by the pieces of the non-bound particulate material, and the packing factor is between 69% and 70%.

23. The current-limiting fuse of claim 20, wherein the non-bound particulate material is associated with a packing factor that indicates a percentage of the interior space that is occupied by the pieces of the non-bound particulate material, and the packing factor is between 62% and 75%.

24. The fuse system of claim 19, wherein the non-bound particulate material fills the interior space of the body of the current-limiting fuse.
